(19) United States
(12) Patent Application Publication
(10) Pub. No.: US 2024/0348289 A1
(43) Pub. Date: Oct. 17, 2024

(54) WIRELESS COMMUNICATION METHOD AND WIRELESS COMMUNICATION SYSTEM

(71) Applicant: NIPPON TELEGRAPH AND TELEPHONE CORPORATION, Tokyo (JP)

(72) Inventors: Yoghitha RAMAMOORTHI, Musashino-shi, Tokyo (JP); Masashi IWABUCHI, Musashino-shi, Tokyo (JP); Tomoaki OGAWA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/294,545

(22) PCT Filed: Aug. 6, 2021
(86) PCT No.: PCT/JP2021/029414

§ 371 Date: Feb. 2, 2024

(51) Int. Cl. H04B 7/024; H04B 7/04; H04W 56/00

(52) U.S. Cl. CPC H04B 7/024; H04B 7/04013; H04W 56/001

(57) ABSTRACT

A wireless communication method of the present disclosure is a wireless communication method in which dual connectivity between a plurality of transmission points and user terminals is used. In the wireless communication method of the present disclosure, a radio link is generated using at least one dynamic reflector between each of a plurality of transmission points and a user terminal. Also, in the wireless communication method of the present disclosure, different data streams are transmitted from the plurality of transmission points to the user terminal via at least one dynamic reflector.

### TECHNICAL FIELD

The present disclosure relates to a wireless communication method and a wireless communication system, and more particularly, to a wireless communication method and a wireless communication system in which a dynamically controllable reflector is used.

### BACKGROUND ART

In recent years, a dynamically controllable reflector (reconfigurable intelligent surface: RIS) has attracted attention. Hereinafter, a dynamically controllable reflector is referred to as a dynamic reflector. A dynamic reflector can dynamically control a phase and an amplitude of radio waves and artificially control the characteristics of radio waves in a propagation path space.

On the other hand, in recent wireless communication systems, a method called coordinated multipoint (COMP) in which a large number of transmission points are deployed and users are supported from a plurality of transmission points in order to increase the overall speed has attracted attention. In particular, NPL 1 proposes assisting COMP transmission with a dynamic reflector. Hereinafter, a transmission method in which a dynamic reflector is used to assist COMP transmission is referred to as RIS-assisted COMP transmission.

RIS-assisted COMP transmission includes a first method schematically shown in FIG. 4 and a second method schematically shown in FIG. 5. The first method is a method in which one transmission point and multiple dynamic reflectors are used. In the example shown in FIG. 4, two identical data streams A transmitted from one transmission point Tx are reflected by two dynamic reflectors RIS1 and RIS2 and transmitted to a user terminal UE. The second method is a method in which a plurality of transmission points and one dynamic reflector are used. In the example shown in FIG. 5, the same data stream A separately transmitted from two transmission points TxA and TxB is reflected by a common dynamic reflector RIS and transmitted to the user terminal UE. In either method, the parameters of the dynamic reflector are controlled by a controller CR associated with the transmission point.

RIS-assisted COMP transmission is expected to be highly effective in improving the reception power of cell-edge users. However, although improvement in coverage can be expected, RIS-assisted COMP transmission still has room for improvement in terms of communication capacity and communication speed. Specifically, a data rate R which can be achieved using the user terminal UE in RIS-assisted COMP transmission is limited to a rate approximately equal to the data rate R A of data stream A.

Note that, in addition to NPL 1, the following NPLs 2 to 6 can be exemplified as literature indicating the technical level at the time of filing in the technical field of the present disclosure.

### CITATION LIST

### Non Patent Literature

[NPL 1] Z. Li, M. Hua, Q. Wang and Q. Song, “Weighted Sum-Rate Maximization for Multi-IRS Aided Cooperative Transmission,” in IEEE Wireless Communications Letters, vol. 9, No. 10, pp. 1620-1624 October 2020: All the elements serve both the BS at all the time. How the RIS resources shared between two TXs is not studied
[NPL 2] M. Hua, Q. Wu, D. W. K. Ng, J. Zhao and L. Yang, “Intelligent Reflecting Surface-Aided Joint Processing Coordinated Multipoint Transmission,” in IEEE Transactions on Communications, vol. 69, No. 3, pp. 1650-1665 March 2021 [NPL 3] Y. Shi, H. Qu and J. Zhao, “Dual-Connectivity Enabled Resource Allocation Approach With eICIC for Throughput Maximization in HetNets With Backhaul Constraint,” in IEEE Wireless Communications Letters, vol. 8, No. 4, pp. 1297-130 August 2019
[NPL 4] M. Pan, T. Lin, C. Chiu and C. Wang, “Downlink Traffic Scheduling for LTE-A Small Cell Networks With Dual Connectivity Enhancement,” in IEEE Communications Letters, vol. 20, No. 4, pp. 796-799, April 2016
[NPL 5] J. Ghimire and C. Rosenberg, “Revisiting scheduling in heterogenous networks when the backhaul is limited,” IEEE Journal on Selected Areas in Communications, vol. 33, No. 10, October 2015
[NPL 6] S. Boyd and L. Vandenberghe, Convex Optimization. Cambridge, U. K.: Cambridge Univ. Press, 2004

### SUMMARY OF INVENTION

### Technical Problem

The present disclosure was made in view of the circumstances described above, and an object of the present disclosure is to provide a technique capable of improving coverage as well as communication capacity and communication speed.

### Solution to Problem

The present disclosure provides a wireless communication method to achieve the above object. A wireless communication method of the present disclosure is a wireless communication method in which dual connectivity between a plurality of transmission points and user terminals is used and includes at least the following steps. A first step includes creating a radio link between each of said plurality of transmission points and a user terminal using at least one dynamic reflector. A second step includes transmitting different data streams from the plurality of transmission points via the at least one dynamic reflector to the user terminal.

The present disclosure provides a wireless communication system to achieve the above object. A wireless communication system according to the present disclosure includes a plurality of transmission points, a user terminal capable of performing communication using dual connectivity and a plurality of dynamic reflectors. A radio link is generated between each of the plurality of transmission points and the user terminal using at least one dynamic reflector of the plurality of dynamic reflectors. Also, different data streams are transmitted from the plurality of transmission points to the user terminal via the at least one dynamic reflector.

### Advantageous Effects of Invention

According to a wireless communication method and a wireless communication system according to the present disclosure, the use of dynamic reflectors to assist communication using dual connectivity can improve coverage as well as communication capacity and speed.

### BRIEF DESCRIPTION OF DRAWINGS

FIG. 1 is a diagram schematically showing a configuration of a wireless communication system according to an embodiment of the present disclosure.

FIG. 2 is a flowchart for describing a wireless communication method relating to the embodiment of the present disclosure.

FIG. 3 is a diagram showing an example of a timeline according to the wireless communication method according to the embodiment of the present disclosure.

FIG. 4 is a diagram schematically showing a first method of RIS-assisted COMP transmission.

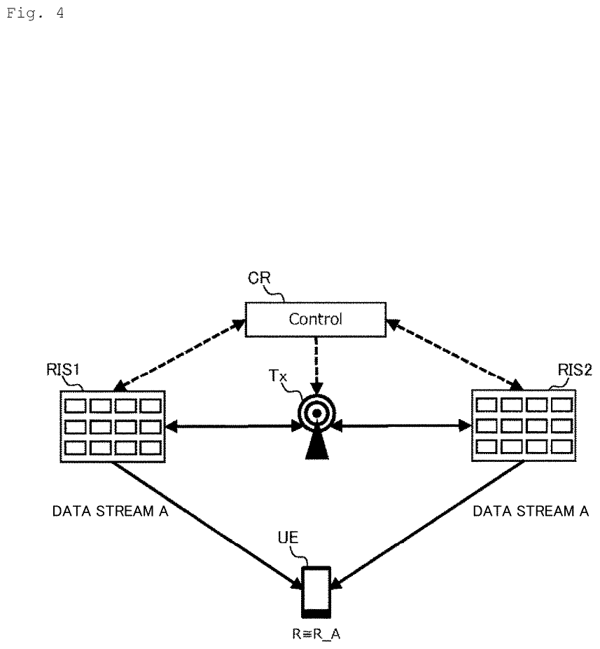

FIG. 5 is a diagram schematically showing a second method of RIS-assisted COMP transmission.

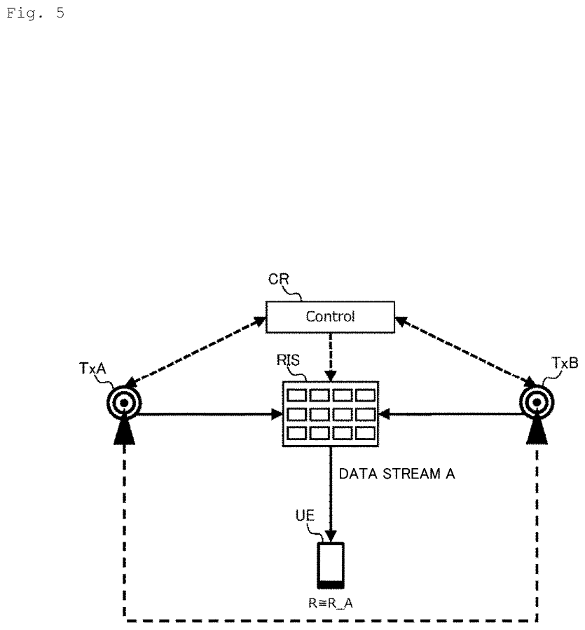

### DESCRIPTION OF EMBODIMENTS

### 1. Wireless Communication System

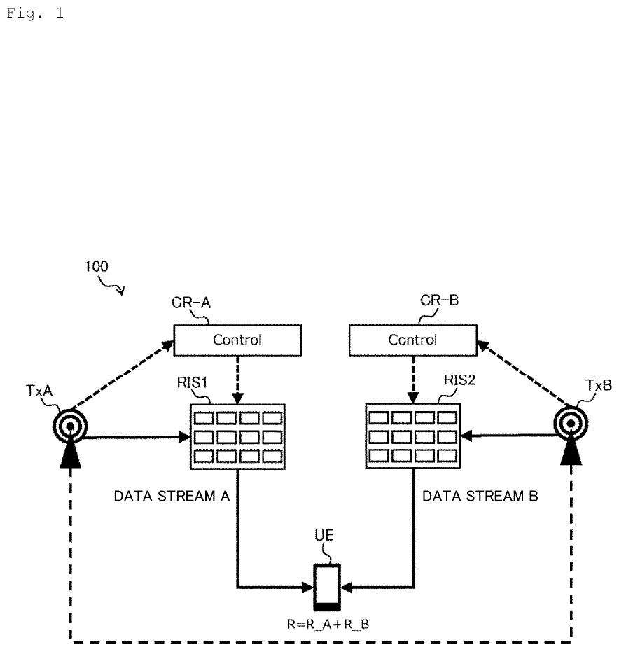

First, a configuration of a wireless communication system according to an embodiment of the present disclosure will be explained using FIG. 1. A wireless communication system 100 shown in FIG. 1 is a system which provides wireless communication using dual connectivity to a user terminal UE in a service area.

The wireless communication system 100 has two transmission points TxA and TxB. The two transmission points TxA and TxB are, for example, base stations providing different wireless communications. In this case, the transmission point TxA may be a primary base station and the transmission point TxB may be a secondary base station. Here, the frequency bands used by the two transmission points TxA and TxB may be the same frequency band, different frequency bands, or different frequency channels in the same frequency band. Note that the two transmission points TxA and TxB are connected through a backhaul line.

The wireless communication system 100 includes two dynamic reflectors RIS1 and RIS2. The dynamic reflectors RIS1 and RIS2 are electromagnetic wave reflectors composed of many passive reflection elements. The reflective elements included in the dynamic reflectors RIS1 and RIS2 are composed of, for example, meta-materials whose properties can be dynamically changed. It is possible to generate a radio link which bypasses obstacles and realize wireless communication which is not affected by obstacles by appropriately changing the reflection characteristics of each reflection element. In the example shown in FIG. 1, the dynamic reflector RIS1 is used for generating a radio link connecting the transmission point TxA and the user terminal UE. Also, the dynamic reflector RIS2 is used for generating a radio link connecting the transmission point TxB and the user terminal UE. The reflection characteristics of each of the dynamic reflectors RIS1 and RIS2 can be controlled by appropriately setting the parameters thereof. The settable parameters are, for example, a phase and an amplitude. In the example shown in FIG. 1, controllers CR-A and CR-B are provided for the dynamic reflectors RIS1 and RIS2, respectively. The controller CR-A sets the parameters of the dynamic reflector RIS1 on the basis of instructions from the transmission point TxA. The controller CR-B sets the parameters of the dynamic reflector RIS2 on the basis of instructions from the transmission point TxB. Note that the controller may be provided for each transmission point, may be provided for each dynamic reflector, or may be provided in an upper network.

A data stream A is transmitted from the transmission point TxA to the user terminal UE via the dynamic reflector RIS1. A data stream B different from the data stream A is transmitted from the transmission point TxB to the user terminal UE via the dynamic reflector RIS2. Thus, the wireless communication system 100 uses the dynamic reflectors RIS1 and RIS2 to help dual connectivity transmission (DC transmission). Hereinafter, the transmission method newly proposed by the present disclosure, that is, the transmission method using the dynamic reflector to assist DC transmission, is referred to as RIS-assisted DC transmission.

According to RIS-assisted DC transmission, the coverage can be improved and the communication capacity and communication speed can also be improved. For example, according to the RIS-assisted DC transmission realized using the system configuration shown in FIG. 1, when wireless resources are assigned on the basis of the proportional fairness criterion, a downlink system throughput can be improved by about 1.5 times compared to conventional DC transmission.

Note that, in the example shown in FIG. 1, there are two transmission points and one dynamic reflector per radio link. However, the RIS-assisted DC transmission proposed by the present disclosure is also applicable to wireless communication systems with three or more transmission points and two or more dynamic reflectors per radio link. Also, the dynamic reflector may be shared between different radio links. In addition, a wireless communication system which realizes RIS-assisted DC transmission proposed by the present disclosure can support not only one user terminal but also multiple user terminals.

### 2. Wireless Communication Method

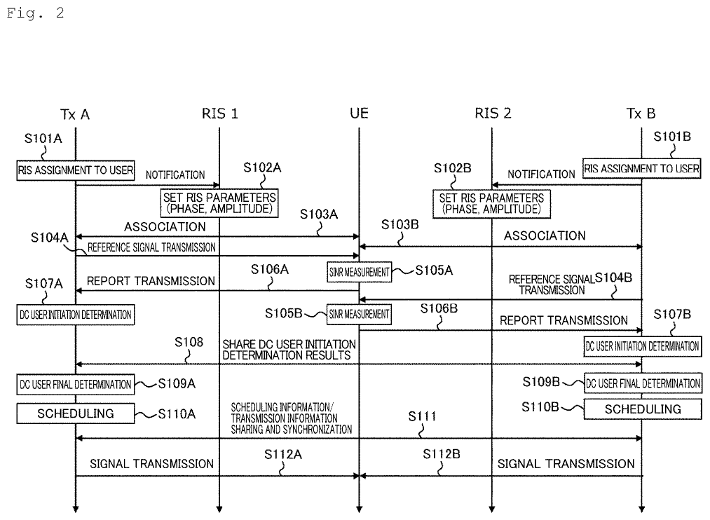

A wireless communication method implemented in the above-described wireless communication system 100, that is, a wireless communication method using RIS-assisted DC transmission, will be described with reference to a flowchart of FIG. 2. In the flowchart, the processes of the transmission point TxA, the transmission point TxB, the dynamic reflector RIS1, the dynamic reflector RIS2, and the user terminal UE, which are components of the wireless communication system 100, and the exchange of signals between the components are shown in chronological order.

First, in Step S101A, the transmission point TxA assigns a dynamic reflector (RIS) to the user terminal UE. Also, in Step S101B, the transmission point TxB assigns a dynamic reflector to the user terminal UE. Here, an upper network may assign dynamic reflectors corresponding to the transmission points TxA and TxB to the user terminal UE, instead of the transmission points TxA and TxB.

Any method may be used for assigning the dynamic reflectors to the user terminals UE. For example, in the first method, each of the transmission points TxA, TxB (or network) sets the reflection direction with respect to the dynamic reflector. Moreover, a test signal is transmitted from each of the transmission points TxA and TxB to the user terminal UE via the dynamic reflector. If the user terminal UE can confirm reception of the test signal, a dynamic reflector which can create a radio link between the transmission points TxA and TxB and the user UE is assigned to the user UE.

As a second method of assigning a dynamic reflector to a user UE, each of the transmission points TxA and TxB (or network) may collect the location information of the user terminal UE and assign the dynamic reflector closest to the user terminal UE. Alternatively, a group of dynamic reflectors in a certain range from the user terminal UE may be identified and collectively assigned to the user terminal UE.

In the example shown in FIG. 2, the transmission point TxA assigns the dynamic reflector RIS1 to the user terminal UE and the transmission point TxB assigns the dynamic reflector RIS2 to the user terminal UE. Each of the dynamic reflectors RIS1 and RIS2 is notified of the assignment result from each of transmission points TxA, and TxB (or network).

Subsequently, in Step S102A, parameters (RIS parameters) of the dynamic reflector RIS1 are set. Also, in Step S102B, the parameters of the dynamic reflector RIS2 are set. The parameters are specifically a phase and an amplitude. A method of setting a parameter and a setting value are arbitrary. For example, a channel between the transmission point and the user terminal via the dynamic reflector may be estimated, a parameter setting value may be calculated using the estimated channel information, or a direction in which the dynamic reflector needs to perform reflection may be estimated using positional information or the like.

Subsequently, in Step S103A, the user terminal UE is connected to the transmission point TxA by exchanging connection signals between the transmission point TxA and the user terminal UE. Also, in Step S103B, the user terminal UE is connected to the transmission point TxB by exchanging connection signals between the transmission point TxB and the user terminal UE. These processes are called associations.

After completing the association between the transmission point TxA and the user terminal UE, in Step S104A, the transmission point TxA transmits reference signals for communication quality measurement to the user terminal UE. Also, after completing the association between the transmission point TxB and the user terminal UE, in Step S104B, the transmission point TxB transmits a reference signal for communication quality measurement to the user terminal UE.

In Step S105A, the user terminal UE measures SINR using the reference signal transmitted from the transmission point TxA. Here, communication quality to be measured is not limited to SINR. SNR, RSSI, or other communication quality may be measured or multiple types of communication quality may be measured. Moreover, in Step S106A, the user terminal UE transmits the communication quality measured in Step S105A to the transmission point TxA.

Also, in Step S105B, the user terminal UE measures SINR using the reference signal transmitted from the transmission point TxB. Although the communication quality to be measured is not limited to SINR, it is preferable to measure the same kind of communication quality as the communication quality measured with the transmission point TxA also with the transmission point TxB. Furthermore, in Step S106B, the user terminal UE transmits the communication quality measured in Step S105B to the transmission point TxB.

In Step S107A, the transmission point TxA determines whether the user terminal UE is a DC user which needs to communicate with DC transmission on the basis of the communication quality acquired in Step S106A. For example, the user terminal UE may be determined as a DC user for the transmission point TxA when the communication quality obtained in Step S106A is a preset threshold value or more and otherwise determined as not a DC user.

Also, in Step S107B, the transmission point TxB determines whether the user terminal UE is a DC user which needs to communicate with DC transmission on the basis of the communication quality acquired in Step S106B. For example, when the communication quality obtained in step S106B is a preset threshold value or more, the user terminal UE may be determined as a DC user for the transmission point TxB and otherwise determined as not a DC user.

Subsequently, in Step S108, the transmission points TxA and TxB perform communication using the backhaul line and share the determination result of Step S107A and the determination result of Step S107B. In addition, in Steps S109A and S109B, each of the transmission points TxA and TxB uses the information shared in Step S108 to make a final decision as to whether the user UE is a DC user. A final determination will be performed in accordance with the table which will be later. According to this table, the user UE is determined as a DC user of the wireless communication system 100 only when the determination result of Step S107A is Yes and the determination result of Step S107B is also Yes.

TABLE 1

| | DC user determination | DC user determination |
|---|---|---|
| | for Tx B: Yes | for Tx B: No |
| DC user determination | Perform DC | Do not perform DC |
| for Tx A: Yes | transmission to user | transmission to user |
| DC user determination | Do not perform DC | Do not perform DC |
| for Tx A: No | transmission to user | transmission to user |

Subsequently, in Step S110A, the transmission point TxA performs scheduling to calculate time resources to be assigned to user terminals UE. Similarly, in Step S110B, the transmission point TxB performs scheduling to calculate time resources to be assigned to user terminals UE.

In scheduling, a globally optimized scheduling time ratio 5 for the entire system is calculated for each dynamic reflector (r) for each transmission point (j) and for each user (u). Note that parameters used in scheduling are defined as shown in the table which will be shown later.

TABLE 2

| | |
|---|---|
| l_{u, j}^{r} | Link rate of user u from Tx j via RIS r |
| x_{u, j}^{r} | Binary user association variable of user u with Tx j via RIS r |
| α | Fairness parameter for the α-Fair scheduler |
| δ_{u, j}^{r} | User scheduling time fraction for user u by Tx j with RIS r |
| ω_{u, j}^{r} | DL received SINR of user u from Tx j via RIS r |
| U | Utility function |
| d_{u, j}^{r} | Binary association variable for DC user |
| λᵤ | Data rate of user u |
| βₙ | Reflection amplitude of element n |
| θₙ | Phase shift of element n |

In scheduling, the following objective function P1 is used for calculating a parameter which maximizes a sum of transmission rates.

$$P 1 : {max}_{\begin{matrix}{β}_{π} , {θ}_{π} , {δ}_{u , j}^{r} , \\ {x}_{u , j}^{r} , {d}_{u , j}^{r}\end{matrix}} {\sum }_{u ∈ U} {U}_{α} ( {λ}_{u} ) , \qquad [ Math . 1 ]$$

In calculating the objective function P1, a fairness index a may be set in advance or the objective function P1 may be calculated to include the determination of the index x. If the index a is 1, it is proportional fairness, and if the index x is made infinite, it is Max-Min fairness. Increasing the exponent a improves the minimum data rate of the system. In the calculation of the objective function P1, the following scheduling expression derived using, for example, the Karush-Kuhn-Tucker condition is used for calculating the schedule time ratio 8.

$${δ}_{u , j}^{r} = \frac{( {x}_{u , j}^{r} + {d}_{u , j}^{r} ) {( {l}_{u , j}^{r} )}^{\frac{1 - ∝}{∝}}}{{\sum }_{u ∈ U} {\sum }_{r ∈ R} ( {x}_{u , j}^{r} + {d}_{u , j}^{r} ) {( {l}_{u , j}^{r} )}^{\frac{1 - ∝}{∝}}} , ∀ j ∈ J , \qquad [ Math . 2 ]$$

A link rate 1 is calculated using the communication qualities acquired in Steps S105A and S105B. For example, the Shannon capacity expression is used. Association variables x and d are obtained in Steps S101A and S101B and Step S108. The association variables x and d which maximize the objective function P1 are finally determined by trialing whether to associate among the obtained results. B and 0 obtained in Steps S102A and 102B are used.

Furthermore, in the above objective function P1, the transmission rate per user terminal is expressed by the following expression.

$$s . t . {λ}_{u} = {\sum }_{r ∈ R} {\sum }_{j ∈ J} {x}_{u , j}^{r} {l}_{u , j}^{r} {δ}_{u , j}^{r} + {\sum }_{r ∈ R} {\sum }_{k ∈ J} {d}_{u , k}^{r} {l}_{u , k}^{r} {δ}_{u , k}^{r} , ∀ u ∈ U , \qquad [ Math . 3 ]$$

The following two expression are conditions for setting the scheduling time ratio.

$${\sum }_{u ∈ U} {\sum }_{r ∈ R} ( {x}_{u , j}^{r} + {d}_{u , j}^{r} ) {δ}_{u , j}^{r} \leq 1 , ∀ j ∈ J , \qquad [ Math . 4 ]$$

$${\sum }_{r ∈ R} {\sum }_{j ∈ J} ( {x}_{u , j}^{r} + {d}_{u , j}^{r} ) \leq 1 , ∀ u ∈ U , \qquad [ Math . 5 ]$$

Also, the setting conditions for each parameter are as follows.

$${x}_{u , j}^{r} = \{ \begin{matrix}1 , & if j , r = arg {max}_{j , r} \{ {ω}_{u , j}^{r} \} , \\ 0 , & otherwise , ∀ u ∈ U , ∀ j ∈ J ,\end{matrix} \qquad [ Math . 6 ]$$

$${d}_{u , k}^{r} = \{ \begin{matrix}1 , & if k , r = arg {max}_{k ∈ J \backslash \{ j \} , r} \{ {ω}_{u , k}^{r} \} , \\ {ω}_{u , j}^{r} \geq τ , & {ω}_{u , k}^{r} \geq τ , \\ 0 , & otherwise , ∀ u ∈ U ,\end{matrix} \qquad [ Math . 7 ]$$

$${x}_{u , j}^{r} ∈ \{ 0 , 1 \} , ∀ u ∈ U , ∀ j ∈ J , ∀ r ∈ R , \qquad [ Math . 8 ]$$

$${d}_{u , j}^{r} ∈ \{ 0 , 1 \} , ∀ u ∈ U , ∀ j ∈ J , ∀ r ∈ R , \qquad [ Math . 9 ]$$

$${δ}_{u , j}^{r} \geq 0 , ∀ u ∈ U , ∀ j ∈ J , ∀ r ∈ R , \qquad [ Math . 10 ]$$

After completion of scheduling in both transmission points TxA and TxB, in Step S111, the transmission points TxA and TxB communicate using the backhaul line and share the scheduling result of Step S110A and the scheduling result of Step S110B. Furthermore, transmission information to be transmitted to the user terminal UE is distributed to each of the transmission points TxA and TxB on the basis of the ratio of transmission rates assigned to the user terminal UE by each of the transmission points TxA and TxB. The transmission rate is calculated as a value obtained by multiplying the data rate calculated from the communication quality (SINR) between the transmission point and the user terminal by the time resource assigned to the user terminal by the transmission point. Also, in Step S111, synchronization processing is performed between the transmission points TxA and TxB as necessary.

Finally, in Step S112A, the transmission point TxA uses the time resource assigned to the user terminal UE by the transmission point TxA in Step S110A to transmit the transmission information distributed to the transmission point TxA in Step S111 to the user terminal UE. Also, in Step S112B, the transmission point TxB uses the time resource assigned to the user terminal UE by the transmission point TxB in Step S110B to transmit the transmission information distributed to the transmission point TxB in Step S111 to the user terminal UE.

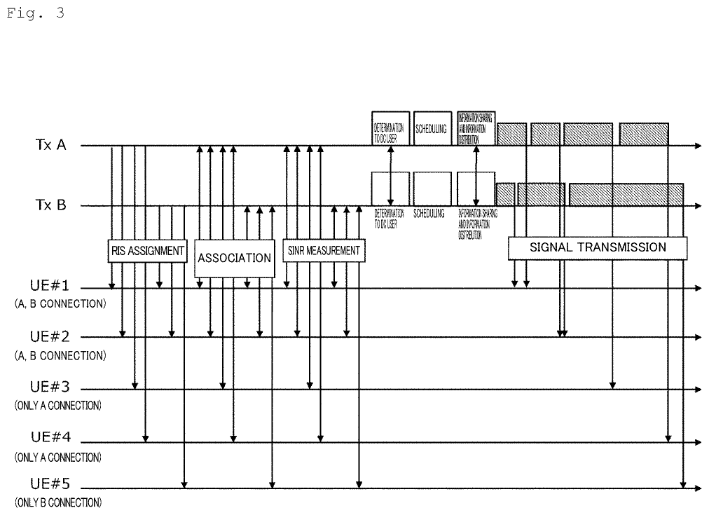

FIG. 3 is a diagram showing an example of a timeline according to the wireless communication method described above. In this timeline, five user terminals UE, #1, #2, #3, #4, and #5, exist in the service area. Of these, the user terminals UE #1 and UE #2 are connected to both transmission points TxA and TxB and wireless communication is performed between the transmission points TxA and TxB by DC transmission, more specifically, RIS-assisted DC transmission. The user terminals UE #3 and UE #4 are each connected only to transmission point TxA and wireless communication using RIS is performed with transmission point TxA. The user terminal UE #5 is connected only to transmission point TxB and wireless communication using RIS is performed with transmission point TxA. As shown in FIG. 3, scheduling is performed so that signals are transmitted from each of the transmission points TxA and TxB at the globally optimized time ratio to include the user terminals UE #1 and UE #2 which perform DC transmission and the user terminals UE #3, UE #4, and UE #5 which do not perform DC transmission.

### 3. Others

The above embodiments can be modified in various ways without departing from the gist of the present disclosure. That is to say, when referring to the number, the quantity, the amount, the range, and the like of each element in the above-described embodiments, unless otherwise specified or clearly specified in principle, the technology according to the present disclosure is not limited by the numbers referred to. Also, the structures and the like described in the above embodiments are not necessarily essential to the technology according to the present disclosure, unless otherwise specified or clearly specified in principle.

### REFERENCE SIGNS LIST

100 Wireless communication system
TxA, TxB Transmission point
UE User terminal
RIS1, RIS2 Dynamic reflector
CR-A, CR-B Controller

1. A wireless communication method in which dual connectivity between a plurality of transmission points and a user terminal is used, the wireless communication method comprising:
generating a radio link between each of the plurality of transmission points and the user terminal using at least one dynamic reflector; and
transmitting different data streams from the plurality of transmission points to the user terminal via the at least one dynamic reflector.

2. The wireless communication method according to claim 1, further comprising:
measuring a communication quality between each of the plurality of transmission points and the user terminal via the at least one dynamic reflector; and
performing communication using the dual connectivity for the user terminal in response to confirmation in which the communication quality exceeds a threshold value at all of the plurality of transmission points.

3. The wireless communication method according to claim 2, wherein the confirmation in which the communication quality exceeds the threshold value at all of the plurality of transmission points includes sharing the measurement results of the communication quality obtained at each of the plurality of transmission points among the plurality of transmission points.

4. The wireless communication method according to claim 1, further comprising:
calculating time resources in which each of the plurality of transmission points need to be assigned to the user terminal; and
distributing transmission information to be transmitted to the user terminal to each of the plurality of transmission points on the basis of the time resources assigned to the user terminal by each of the plurality of transmission points.

5. The wireless communication method according to claim 4, wherein the distributing of the transmission information to each of the plurality of transmission points is performed on the basis of communication quality between each of the plurality of transmission points and the user terminal via the at least one dynamic reflector.

6. The wireless communication method according to claim 4, wherein
the distributing of the transmission information to each of the plurality of transmission points is performed through sharing, among the plurality of transmission points, the time resources assigned to the user terminal by each of the plurality of transmission points.

7. The wireless communication method according to claim 4, further comprising:
after performing synchronization processing among the plurality of transmission points, transmitting the transmission information distributed to each of the plurality of transmission points using the time resources assigned to the user terminal by each of the plurality of transmission points.

8. A wireless communication system comprising:
a plurality of transmission points:
a user terminal capable of performing communication using dual connectivity; and a plurality of dynamic reflectors:
wherein a radio link is generated between each of the plurality of transmission points and the user terminal using at least one dynamic reflector of the plurality of dynamic reflectors, and different data streams are transmitted to the user terminal from the plurality of transmission points via the at least one dynamic reflector.
